(19) United States
(12) Patent Application Publication
(10) Pub. No.: US 2019/0124942 A1
(43) Pub. Date: May 2, 2019

(54) ANHYDROUS FOOD PRODUCT WITH A BASE OF COCOA BUTTER AND DRY PLANT MATERIAL

(71) Applicant: SONAFI, VIROFLAY (FR)

(72) Inventors: Julien Bourgeay, SAINT DONAT SUR L'HERBASSE (FR); Alban Claveyrolat, CHATEAUNEUF-SUR-ISERE (FR); Aurélie Saglio, FONTAINEBLEAU (FR)

(73) Assignee: SONAFI, VIROFLAY (FR)

(21) Appl. No.: 16/306,040

(22) PCT Filed: Jun. 13, 2017
(86) PCT No.: PCT/EP2017/064423

§ 371 Date: Nov. 30, 2018

(30) Foreign Application Priority Data
Jun. 14, 2016 (FR) 1655470

(51) Int. Cl. A23G 1/36; A23G 1/40; A23G 1/46; A23G 1/48; A23G 1/52; A23G 3/40; A23G 3/42; A23G 3/46; A23G 9/46; A23G 3/48; A23G 3/52; A23G 9/32; A23G 9/34; A23G 9/40; A23G 9/42

(52) U.S. Cl. CPC A23G 1/36; A23V 2002/00; A23G 1/46; A23G 1/48; A23G 1/52; A23G 3/40; A23G 3/42; A23G 3/46; A23G 9/46; A23G 3/48; A23G 3/52; A23G 9/327; A23G 9/34; A23G 9/40; A23G 9/42; A23G 1/40

(57) ABSTRACT

The present invention relates to a new anhydrous food product with a base of cocoa butter and dry plant material, designed to be hydrated to allow rapid and simple production of sweet or savoury prepared food products. The invention also relates to a method for the production thereof and to the use thereof for manufacturing prepared food products.

The present invention relates to the field of the food industry.

It relates more specifically to a new anhydrous food product with a base of cocoa butter and dry plant material (fruit, vegetable, spice, dry cocoa material, etc.); this anhydrous food product is designed to be hydrated and allow rapid and simple production of sweet or savoury prepared food products. More specifically, this new anhydrous food product makes it possible, after rehydration, to produce prepared food products of different textures according to the quantity of hydrating agent added. Regardless of the texture sought in the final product, said product, through its concentrated aromatic profile, makes it possible to obtain an optimum taste (intense, distinct, pronounced, etc.), compared to similar products obtained with conventional practices. The product according to the invention can be stored one year in storage conditions similar to that used for a chocolate without having any organoleptic or structural defect.

Currently, the raw materials containing cocoa butter used by catering professionals (chocolate makers, pastry chefs and cooks, etc.) for the production of prepared food products (ganaches, mousses, pastry cream, ice-creams, beverages, etc.) consist substantially of chocolates, in particular couverture chocolate, or pure cocoa butter.

Chocolate is used as a vector of flavouring but also as a texturizing agent thanks to the cocoa butter that it contains. The production of prepared food products with a base of chocolate consists of adding to the chocolate food materials (for example, cream, butter, sugar, egg, etc.) making it possible to vary the texture of the final product.

Cocoa butter is used in the production of prepared food products as a texturizing agent, in order to provide “cold-state” hardness and melting in the mouth.

The preparation of chocolate desserts requires long and delicate working of the chocolate in order to transform it into an ingredient for desserts (ganache, mousse, pastry cream, ice-cream for example). Indeed, the formulation of these desserts is rendered complex by the balances to be found between the various “texturizing” fatty phases, the aqueous phase, and the quantity of dry materials but also due to the emulsification step, i.e. the intimate mixing between fatty phase and aqueous phase, which will determine the final texture and the preservation of the prepared food product.

By way of example, for the preparation of a ganache, the steps are generally the following: a mixture of cream and sugar is brought to a boil and poured little by little over chocolate then the whole is homogenised by mixing. For the mixing it is possible to use for example a spatula, a sheet, a grinding mixer with or without vacuum and the hand blender. Once the mixing is completed, it is recommended to check that the temperature of the mixture does not exceed 40° C. before adding dairy butter in pieces.

The cooking and pastry practices consisting of producing an emulsion are the basis of various products ranging from ganache to beverages including creamy, mousse textures or ice-creams.

It is the balance between the various fats, the aqueous phase, and the non-fat dry materials, that makes it possible to obtain, after emulsification, these varied textures.

This balance is delicate to obtain because the manufacture of these prepared food products consists of mixing various raw materials that are already complex (for example, cream itself comprises water, milk fat, carbohydrates and proteins).

It is by studying the microscopic structure of chocolate ganaches and then conducting tests on the optimisation of the physico-chemical properties of the latter that the Applicant developed a new anhydrous food product with a base of cocoa butter and dry plant material.

The first tests were initially conducted with dry cocoa material but they were rapidly extended to other dry materials derived, for example, from fruits, vegetables, spices, cereals, etc. The composition and the physico-chemical properties of said product—intended for applications identical to chocolate applications—allow for a simplification of implementation, and savings in time as well as a faster texturizing of prepared food products such as pastry desserts. The formulation of said product makes it possible to maximise its preservation while still facilitating the obtaining of different textures and an optimum taste compared to similar applications obtained by conventional practices.

More specifically, this anhydrous food product with a base of cocoa butter and dry plant material is composed of various anhydrous ingredients. It forms a concentrated mixture (for example, in the case of a chocolate ganache, it would be a ganache free of water) and has physico-chemical properties of chocolate in the raw state (rheology, moisture, crystallisation, shelf life, etc.).

An optimised formulation (choice of ingredients and balancing of the recipe) as well as a specific method (thin grinding and conching of all of its ingredients) provides this anhydrous food product with innovative organoleptic properties (aromatic and texture) after rehydration.

The use of said product advantageously simplifies the work of the person skilled in the art by reducing the overall implementation time and by limiting the manufacturing constraints (storage of raw materials, work space management, controlling the manufacturing parameters, etc.). The implementation of said product facilitates the division of the prepared food products into different textures for a given aromatic profile while still limiting the risk of defects that can occur during the implementation of the various ingredients.

More generally, the anhydrous food product offers the possibility of manufacturing prepared food products having a very large range of textures without modifying the aromatic profile conferred by the dry plant material or materials used.

Anhydrous Food Product

The present invention thus relates to an anhydrous food product comprising:
between 15% and 40% by weight of cocoa butter;
between 3% and 50% or between 5% and 50% by weight of dry plant material;
between 10% and 50%, preferably, between 10% and 38%, by weight of mono-, di- and/or polysaccharides;
between 10% and 40% by weight of fat having an SFC less than or equal to 40% at 20° C.;
optionally up to 30% by weight of dry dairy material;
optionally up to 20% by weight of sweetening agent;
optionally up to 8% by weight of spices; and
optionally up to 5% by weight of emulsifier;
   this product is such that:
the weight ratio between the fat having an SFC less than or equal to 40% at 20° C. and the cocoa butter is greater than 0.25;
its water content is less than 5% by weight; and
the dry material of the product has a D(90) less than or equal to 50 microns in the finished product.

Optionally, the anhydrous food product according to the invention is such that the weight ratio between the total fat (cocoa butter and mass of fat having an SFC less than or equal to 40% at 20° C.) and the total non-fat dry material is greater than or equal to 0.7.

The term cocoa butter means a product coming entirely from cocoa beans defined by the legal current name (DIRECTIVE 2000/36/EC OF THE EUROPEAN PARLIAMENT AND OF THE COUNCIL of the 23 Jun. 2000, concerning cocoa and chocolate products intended for food).

The term dry plant material means whole or fragmented plants, non-fat and dehydrated or partially dehydrated.

Without limitation, this dry plant material can come from cocoa (ground cocoa, roasted cocoa bean fermented or not, cocoa powder), fruits (citrus such as lemon, orange, grapefruit, lime, etc.; berries such as strawberry, raspberry, currant, grape, etc.; stone fruits such as apple, pear, etc.; stone fruit such as apricot, cherry, peach, olive, etc.; nuts such as hazelnut, walnut, almond, etc.; fruit from tropical regions such as pineapple, banana, mango, passion fruit, etc.), vegetables (root vegetables such as carrot, parsnip, beet, etc.: fruiting vegetables such as tomato, pepper, squash, etc.; leafy vegetables such as spinach, cabbage, leek, etc.; pulse vegetables such as peas, beans, etc.; bulb vegetables such as garlic, onion, shallot, etc. or mushrooms), cereals, edible flours, condiments, aromatic herbs, etc. or mixtures thereof.

The terms mono-, di- and polysaccharides, mean a sugar comprised respectively of one, two or several uses. Mention can be made, without limitation, among the monosaccharides, of fructose, galactose, glucose, etc.; among the disaccharides, sucrose, maltose, lactose, etc.; among the polysaccharides, inulin, starch, amylopectin, cellulose, dextrin, pectin, agar-agar, carrageenans, maltodextrins (products resulting from the hydrolysis of starch). These sugars can be used alone or in a mixture.

The use of mono-, di- and polysaccharides can fulfil one and/or the other of the following functions: provide a sweet taste to the anhydrous food product according to the invention and/or play the role of a bulking agent.

In order to provide a sweet taste, sucrose will preferably be used.

Sugars that have bulking agent properties are preferably chosen from the polysaccharides.

The term fat having an SFC less than or equal to 40% at 20° C. means the animal and/or plant fat (except cocoa butter) characterised by a solid fat content (designated as SFC hereinafter) less than or equal to 40% at 20° C. In order to achieve this value of SFC, the person skilled in the art knows how to mix and/or split the fat available in order to optimise the melting profile thereof. The fat having an SFC less than or equal to 40% at 20° C. plays a texturizing role in the product according to the invention by providing a melting property to the rehydrated product.

Preferably, the fat having an SFC less than or equal to 40% at 20° C. is a fat derived from dairy products for example chosen from a product derived from the total or partial dehydration of whole milk, of partially skimmed milk, of cream, of butter or of milk fat.

The term dry dairy material means a dehydrated or partially dehydrated and non-fat material and derived from dairy products such as defined hereinabove.

The fat content having an SFC less than or equal to 40% at 20° C. and the content in dry dairy material can be achieved by using dairy products coming from the total or partial dehydration of whole milk, of partially or totally skimmed milk, of cream, of butter or of milk fat.

The term sweetening agent means any polyol and sweetener that could be useful to add to the anhydrous food product according to the invention if the sweetening power of the mono-, di- and/or polysaccharides already used is not sufficient. Another advantage in using these ingredients results from their anti-crystallising and/or moistening properties.

The spice or spices, including spice extracts, are chosen by the person skilled in the art according to the taste that he/she wants to give to the product according to the invention; preferably, it is vanilla.

Any food emulsifier can be used for the preparation of the product according to the invention (lecithin, Tween, mono- and diglyceride, lactic esters of fatty acids, etc.); preferably, the emulsifier is lecithin.

The raw materials used for the preparation of the product according to the invention must be anhydrous, i.e. their water content must be less than 10% by weight.

The physico-chemical properties of the product according to the invention are important so that the use thereof provides benefits in terms of quality to the prepared food products using said anhydrous food product, of simplification and of rapidity in the manufacturing thereof.

Thus, preferably, the rheology of the product according to the invention is such that it has a viscosity between 0.2 and 5 Pa.s and/or a flow limit between 2 and 35 Pa according to the 100002000 method (International Office of Cocoa, Chocolate and sugar Confectionery)—Measurements taken on a Haake™ Mars III ThermoFisher rheometer.

The product according to the invention also has the characteristic of being able to be formed as a chocolate by following good practices known to the person skilled in the art; i.e. it can be tempered, then cooled in a mould and be released easily after cooling in order to obtain the desired shape.

The composition of the product according to the invention can be adjusted according to the use that is to be made of it.

Thus, according to a first embodiment, the anhydrous food product according to the invention has a base of cocoa butter and of cocoa dry plant material and comprises:
between 15% and 40% by weight of cocoa butter;
between 3% and 40% by weight of dry non-fat cocoa powder;
   the content in cocoa butter and in non-fat dry cocoa can be achieved by using cocoa or cocoa products such as cocoa beans or bean fragments in different forms (ground cocoa, liquor, nibs, etc.), of partially or entirely de-fatted beans (non-fat liquor, cocoa powder, etc.) or a mixture of these various ingredients;
between 15% and 50%, preferably between 15% and 38%, by weight of mono-, di- and/or polysaccharides; preferably between 25% and 35%;
between 10% and 40% by weight of fat having an SFC less than or equal to 40% at 20° C.; preferably between 15% and 25%; preferably, it is a milk fat;
optionally up to 30% by weight of dry dairy material;
   fat content having an SFC less than or equal to 40% at 20° C. and dry dairy material content can be achieved by using dairy products derived from the total or partial dehydration of whole milk, of partially or totally skimmed milk, of cream, of butter or of milk fat;
optionally up to 20% by weight of sweetening agent;
optionally up to 8% by weight of spices or spice extracts; preferably between 1 and 2% of spices, for example vanilla;
optionally up to 5% by weight of emulsifier; preferably between 0.5% and 1%, for example of soy lecithin;
   this product is such that:
the weight ratio between the fat having an SFC less than or equal to 40% at 20° C. and the cocoa butter is greater than 0.25;
optionally, the weight ratio between the total fat and the total non-fat dry material is greater than or equal to 0.7;
its water content is less than 5% by weight; and
the dry material of the product has a D(90) less than or equal to 50 microns in the finished product.

The composition of the anhydrous food product with a base of cocoa butter and cocoa dry plant material can be adapted according to the intensity of the taste sought.

Thus, in order to obtain an aromatic profile of the “dark chocolate” type (after rehydration), the anhydrous food product according to the invention has a base of cocoa butter and of cocoa dry plant material and comprises:
between 20% and 40% by weight of cocoa butter;
between 10% and 40% by weight of dry non-fat cocoa powder;
   the content of cocoa butter and of non-fat dry cocoa can be achieved by using cocoa or cocoa products such as cocoa beans or bean fragments in different forms (ground cocoa, liquor, nibs, etc.), of partially or entirely de-fatted beans (non-fat liquor, cocoa powder, etc.) or a mixture of these various ingredients;
between 20% and 45%, preferably between 20% and 38%, by weight of mono-, di- and/or polysaccharides;
between 10% and 30% by weight of fat having an SFC less than or equal to 40% at 20° C.; more preferably it is milk fat;
optionally up to 20% by weight of dry dairy material;

fat content having an SFC less than or equal to 40% at 20° C. and dry dairy material content can be achieved by using dairy products derived from partial or total dehydration of whole milk, from partially or totally skimmed milk, from cream, from partially or totally dehydrated cream, from butter or from milk fat;
optionally up to 20% by weight of sweetening agent;
optionally up to 5% by weight of spices; preferably between 0 and 1.5%, for example vanilla;
optionally up to 5% by weight of emulsifier; preferably between 0.5% and 1%, for example soy lecithin;
   this product is such that:
the weight ratio between the fat having an SFC less than or equal to 40% at 20° C. and the cocoa butter is greater than 0.25;
optionally, the weight ratio between the total fat and the total non-fat dry material is greater than or equal to 0.7;
its water content is less than 5% by weight; and
the dry material of the product has a D(90) less than or equal to 50 microns in the finished product.

In order to obtain an aromatic profile of the milk chocolate type, the anhydrous food product according to the invention has a base of cocoa butter and of cocoa dry plant material and comprises:
between 15% and 30% by weight of cocoa butter;
between 3% and 20% by weight of dry non-fat cocoa powder;
   the content of cocoa butter and of non-fat dry cocoa can be achieved by using cocoa or cocoa products such as cocoa beans or bean fragments in different forms (ground cocoa, liquor, nibs, etc.), of partially or entirely de-fatted beans (non-fat liquor, cocoa powder, etc.) or a mixture of these various ingredients;
between 20% and 50%, more preferably between 20% and 38%, by weight of mono-, di- and/or polysaccharides;
between 10% and 20% by weight of fat having an SFC less than or equal to 40% at 20° C.; more preferably it is milk fat;
between 10% and 30% by weight of dry dairy material;
   fat content having an SFC less than or equal to 40% at 20° C. and dry dairy material content can be achieved by using dairy products derived from partial or total dehydration of whole milk, from partially or totally skimmed milk, from cream, from partially or totally dehydrated cream, from butter or from milk fat;
optionally up to 20% by weight of sweetening agent;
optionally up to 5% by weight of spices; preferably between 0 and 1.5%, for example vanilla.
optionally up to 5% by weight of emulsifier; preferably between 0.5 0 and 1%, for example soy lecithin;
   this product is such that:
the weight ratio between the fat having an SFC less than or equal to 40% at 20° C. and the cocoa butter is greater than 0.25;
optionally, the weight ratio between the total fat and the total non-fat dry material is greater than or equal to 0.7;
its water content is less than 5% by weight.
the dry material of the product has a D(90) less than or equal to 50 microns in the finished product.

According to a second embodiment, the anhydrous food product according to the invention has a base of cocoa butter and of fruit and/or vegetable dry plant material and comprises:
between 15% and 40% by weight of cocoa butter;
between 5% and 50% by weight of dehydrated fruit and/or vegetable; preferably between 15 and 25%;
between 15% and 50% by weight of mono-, di- and/or polysaccharides; preferably between 25 and 45%;
between 10% and 40% by weight of fat having an SFC less than or equal to 40% at 20° C.; preferably between 15% and 25%; preferably, it is milk fat;
optionally up to 30% by weight of dry dairy material; preferably less than 15%;
   the proportions of milk fat or derivatives and of dry dairy material can be achieved by using dairy products derived from partial or total dehydration of whole milk, from partially or totally skimmed milk, from cream, from partially or totally dehydrated cream, from butter or from milk fat;
optionally up to 20% by weight of sweetening agent;
optionally up to 8% by weight of spices;
optionally up to 5% by weight of emulsifier; preferably between 0.5% and 1%, for example of soy lecithin;
   this product is such that:
the weight ratio between the fat having an SFC less than or equal to 40% at 20° C. and the cocoa butter is greater than 0.25;
optionally, the weight ratio between the total fat and the total non-fat dry material is greater than or equal to 0.7;
its water content is less than 5% by weight; and
the dry material of the product has a D(90) less than or equal to 50 microns in the finished product.

The anhydrous food product according to the invention prepared using these two embodiments makes it possible, after rehydration, to produce prepared food products, of different textures (of the ganache, creamy, sauce, beverage, mousse, ice-cream type for example), according to the quantity of hydrating agent added.

Method for the Production of the Anhydrous Food Product According to the Invention

The present invention also relates to a method for preparing the anhydrous food product; according to the invention, this method comprises the following steps:

### a) Grinding and Homogenising

This first step consists of mixing and grinding the various ingredients of the invention until a mass is obtained of which the grain size is characterised by a D(90) less than or equal to 50 microns. This mass must then be homogenised by stirring and maintaining a temperature between 35 and 75° C.
It is then possible to conch (stir and aerate the mass) for up to 72 h in order to aerate and deacidify the mass to obtain the aromatic profile sought.
For the purposes of information, the following grinding and/or conching tools can be used: 2- or 5-cylinder grinders (Buhler or Carle & Montanan), pin mills (MAP type from Carle & Montanan), hammer mills (SCS or SUM type from Bühler), or knife mills (Bauermeister), ball mills (Buhler, Wiener), compressed air mills (Alpine, Hosokawa), so-called universal mills (RoboQbo, Stephan), continuous grinding systems (NAGEMA), so-called universal conches (MacIntyre), conches with one or several horizontal axes (Frisse, Thouet), vertical axes(Carle & Montanan, Petzholdt) or with an inclined axis (Bauermeister)
b) Tempering of the product, in order to control the crystallisation of the cocoa butter and of the fat having an SFC≤40% at 20° C., for an optimum implementation of the product;
c) Moulding of the product obtained at the end of the step b) of tempering; it can be moulded in different forms (drops, beans, tablet, blocks or cast into buckets for example).

Use of the Anhydrous Food Product According to the Invention

The present invention also relates to the use of the anhydrous food product according to the invention for manufacturing a prepared food product; regardless of the application considered, the use of this product requires adding a hydrating agent.

According to the invention, the hydrating agent is an aqueous liquid such as water, infusions, soup, tea, coffee, juice (fruit, vegetable, plant, fish, meat), animal/plant milk, etc. the hydrating agent is formed from at least 80% of water.

According to the applications considered, the weight ratio between the hydrating agent and the anhydrous food product is between 0.1 and 4.

The quantity of hydrating agent to be added to the anhydrous food product is determined according to its water content and the texture sought for the final application.

The quantity of hydrating agent determines the final texture of the application as well as its shelf life; it should be underlined concerning the hydrating agent added that:
if it is water, it does not denature the aromatic profile of the anhydrous food product according to the invention. This is a substantial advantage compared to the conventional methods, which require adding ingredients such as cream, eggs, sugar, etc., an addition that has for effect to modify, or alter, the taste of the initial product. The invention thus makes it possible to obtain an aromatic profile that is retained regardless of the textures sought;
if it consists of fruit juice or of coffee for example, it can provide additional sought flavourings.

For the purposes of illustration, the table hereinafter indicates the ranges of quantity of hydrating agent to be added to the anhydrous food product according to the invention, depending on the type of prepared food product. This table also specifies any methods to be implemented in addition to the prior step of preparing the emulsion with the anhydrous food product according to the invention and the hydrating agent.

| | % by weight of | | |
|---|---|---|---|
| Applications | hydrating agent based on | | |
| (type of | the total weight of the | | Additional |
| prepared | prepared food product | | methods to |
| food product) | Minimum | Maximum | the emulsion |
| Ganaches | 10% | 35% | — |
| Mousses | 20% | 50% | Whipping |
| Creamy | 35% | 60% | — |
| Sauces | 35% | 60% | — |
| Ices (sorbet or | 40% | 80% | Whipping + |
| ice-cream) | | | Freezing |
| Beverages | 45% | 80% | — |

By way of example, the comparison of a chocolate emulsion obtained with the anhydrous food product according to the first embodiment of the invention, to which is added a hydrating agent, with a chocolate emulsion of the same composition obtained by a conventional method was conducted as detailed in the example III and shows that:
the texturizing (crystallising) of the emulsion obtained with the anhydrous food product according to the invention is at least twice as fast;
its aromatic profile is not denatured by the “texturizing” ingredients added in the conventional method (cream, milk, egg, sugar, etc.); and
its texture is similar to that of the application obtained by the techniques known to the person skilled in the art, both during the implementation and during the preservation.

More specifically, the comparison of a ganache prepared using the anhydrous food product according to the invention and of a hydrating agent such as water with a ganache prepared according to a conventional recipe (mixture of chocolate, cream, butter and sugar) shows that the prepared food product using the product according to the invention has characteristics that are similar and/or improved with respect to that of the so-called conventional ganache:
a pasty to semi-solid consistency, allowing for “conventional” work by the person skilled in the art;
a major decrystallizing at a temperature of 40° C.;
a quick and clean cut;
stability in freezing and thawing;
low sensitivity to oxidation.

When the anhydrous food product according to the invention is used for the manufacturing of a whipped prepared food product, a mousse for example, the method to be implemented is very simple since it is sufficient to add the hydrating agent to the product according to the invention (between 20% and 50%) and to whip the mixture. A beater, a food processor or any other system for incorporating gas can be used.

The present invention thus relates to a whipped prepared food product made of the anhydrous food product according to the invention and having a quantity of hydrating agent between 20% and 50% by weight based on the total weight of said product and to its method of manufacturing, which comprises the steps of:
mixing said hydrating agent and said anhydrous food product; and
whipping said mixture with a system for incorporating gas.

It should be noted that a conventional method of preparing pastry chocolate mousse generally requires the use of a dairy product (of the cream type) or eggs that were whipped beforehand and then progressively incorporated into the mass. For applications with fruits/vegetables, the use of gelatine is often recommended.

In addition to the ease of preparation, the mousse obtained using the anhydrous food product according to the invention is aerated, soft and is as stable over time than a mousse obtained by a conventional method of manufacturing.

When the anhydrous food product according to the invention is used for the preparation of an ice-cream, the method to be implemented consists of mixing between 40% and 80% by weight of a hydrating agent (preferably water) with the anhydrous food product, in mixing, in processing between −6 and −10° C. and finally in storing the preparation in the freezer (preferably at −18° C.).

The ice-cream thus obtained has the same organoleptic characteristics, texture and preservation as that obtained by the techniques known to the person skilled in the art for the same final formula.

The present invention also relates to an ice-cream prepared with the anhydrous food product according to the invention and having a quantity of hydrating agent between 20% and 60% by weight based on the total weight of said product and to its method of manufacturing, which comprises the steps of:
mixing said hydrating agent and said anhydrous food product; and
mixing and processing said mixture between −6 and −10° C.; and
storing in the freezer.

The conventional method of manufacturing an ice-cream comprises, by way of example, the following steps: pouring water or milk into a cooking appliance; at 25° C., adding 0% milk powder; at 30° C., adding sugars; at 40° C., incorporating the fatty products: the fat (the cream, egg yolks and optionally the chocolate); at 45° C., adding the final ingredients by incorporating the stabiliser/emulsifier mixture added to a portion of initial sugar (about 10%); pasteurising the preparation at 85° C. for 2 minutes then quickly cooling the mix to +4° C.; if possible, homogenising the mix in order to disperse the molecules of fat that are as fine as possible and letting the mix “mature” for a minimum of 12 hours; finally, mixing and processing between −6 and −10° C. and storing in the freezer at −18° C.

The method for preparing ice-cream using the anhydrous food product according to the invention makes it possible to overcome the steps of controlling the temperature, the step of pasteurisation as well as the maturation phase. Consequently, the use of the anhydrous food product according to the invention for the preparation of ice-cream allows for a substantial amount of time to be saved for an identical result with the same final formula.

It should also be noted that the optimisation of the various ingredients of the product according to the invention limits the risks of defects during the implementation and preservation, regardless of the applications considered.

By way of example, using said product makes it possible to limit the appearance of dephasing during the preparation of emulsified applications (such as ganache). Indeed, the optimisation, in particular, of the following ratios:
the weight ratio between the fat having an SFC less than or equal to 40% at 20° C. and the cocoa butter is greater than 0.25;
the weight ratio between the dry material and the total fat.

allows for optimal balancing, regardless of the quantity of hydrating agent added.

In addition, the appearance during the preservation of defects that were not visible during the implementation is also limited by the optimisation of the balancing of the anhydrous food product with a base of cocoa butter according to the invention.

### FIGURES

FIGS. 1A and 1B. FIGS. 1A and B show the texture profile after 30 min and 24 h at 4° C. of three prepared food products: Ganache A, Ganache C and the Chocolate-water mixture C of which the recipes are detailed in the example III.

FIG. 2. FIG. 2 is a graph that shows the maximum constraint threshold of Ganaches A and C.

FIG. 3. FIG. 3 is a graph that shows the “cutability” threshold of Ganaches A and C.

FIG. 4. FIG. 4 shows the change in the maximum constraint as a function of time of two prepared food products: Creamy A and Creamy C, the recipes of which are detailed in the example III.

### EXAMPLES

### I. Preparation of an Anhydrous Food Product According to the Invention

A merchantable cocoa is transformed into ground cocoa (or nib) after the steps of roasting and crushing. The ground cocoa is then ground in order to obtain a semi-finished liquid product at 45° C. called cocoa liquor. This liquor is mixed in a kneader with various raw materials in the following proportions (expressed by weight):
Cocoa liquor: 39.1%
Cocoa butter: 4.8%
Skimmed milk powder: 2.2%
Sucre: 25.4%
Milk fat: 28.3%
Soy lecithin: 0.3%

The mixture is then ground until a mass having a D(90) less than or equal to 50 microns is obtained and then conched for 48 h at a temperature between 50° C. and 70° C. The mass is then tempered and moulded into beans of 3.5 g, which are packaged in bags after crystallisation.

The product obtained in designated as Product A.

### II. Manufacturing a Prepared Food Product (Ganache) Using the Product A According to the Example I

The manufacturing consists of pouring 21% by weight of boiling water on 79% by weight of beans of Product A and in homogenising the preparation by stirring.

The ganache thus obtained is designated as Ganache A.

III. Comparison of the Rheological Behaviour of the Prepared Food Product of the Example II (Ganache A) with that of the Existing Food Products (Conventional Chocolate and Ganache)

In order to carry out the comparative tests, a Ganache C having a composition identical to that of the Ganache A is prepared according to a conventional method with a Chocolate C.

The Chocolate C made of: 63.2% of cocoa bean, 7.7% of cocoa butter, 28.7% of sugar, 0.4% of lecithin.

This Chocolate C is implemented according to the following ganache recipe (referred to as conventional) (proportions expressed by weight):
700 g of Chocolate C;
500 g of cream 35% fat;
90 g of sugar;
150 g of dairy butter.

The cream/sugar mixture is brought to a boil then poured little by little on the chocolate; the preparation is then homogenised by stirring. Once the mixture is completed, a check of the temperature is carried out in order to ensure that the mixture does not exceed 40° C. At 39° C., the dairy butter is added in pieces.

Comparison of Ganaches A and C

The composition of the two ganaches obtained by these two methods of preparation is detailed in the table below, these compositions are substantially identical:

| | Ganache A | Ganache C |
|---|---|---|
| Cocoa butter | 20.4% | 20.4% |
| Cocoa dry material | 14.3% | 14.3% |
| Milk fat | 22.3% | 22.3% |
| Milk fat | 1.8% | 1.8% |
| Sugar | 20.1% | 20.1% |
| Water | 21.1% | 21.1% |

The proportions of fat and of dry cocoa material FOR the cocoa liquor used are as follows:

| | Dry material | Fat |
|---|---|---|
| Cocoa liquor | 46% | 54% |

The proportions of water, of dry material (DM) of milk and of milk fat for the 35% fat cream are as follows:

| | Water | Dairy DM | Milk fat |
|---|---|---|---|
| 35% fat cream | 60% | 5% | 35% |

The preparation of the Ganache A with the Product A is much simpler and faster than the conventional method for preparation used to manufacture the Ganache C.
a) Texture after Crystallising

It is proposed to evaluate using a vane shear test the characteristics of the Ganaches A and C as well as the product resulting from the mixture of Chocolate C with 21% water according to the method used for the implementation of Ganache A (this product is designated as Chocolate-water mixture C).

### Equipment and Vane Shear Test Method

The apparatus used is a Mars III, ThermoFisher rheometer.

In order to evaluate the texture of the various products to be analysed, a vane shear testing analysis protocol was used. The protocol makes it possible to characterise the change in their texture from the moment they are manufactured.

The texture of the various food preparations is evaluated using a Mars III (Thermofisher) rheometer, provided with a metal vane with four blades with a diameter of 16 mm and a height of 10 mm. The vane descends vertically into the application at a speed of 20 mm/s, and then carries out a rotation at the imposed speed of 0.02 rad/s for 5 min. The measurement is taken at an ambient temperature of 20° C. A reading of the constraint required to maintain the imposed rotation speed is carried out.

The analysed application is packaged in a fixed-size container, in such a way that:
the height of the product under the vane is 10 mm;
the distance between the end of the vane and the edge of the product is 16 mm;
the top of the vane is at the same height as the planar surface of the application.

### Results

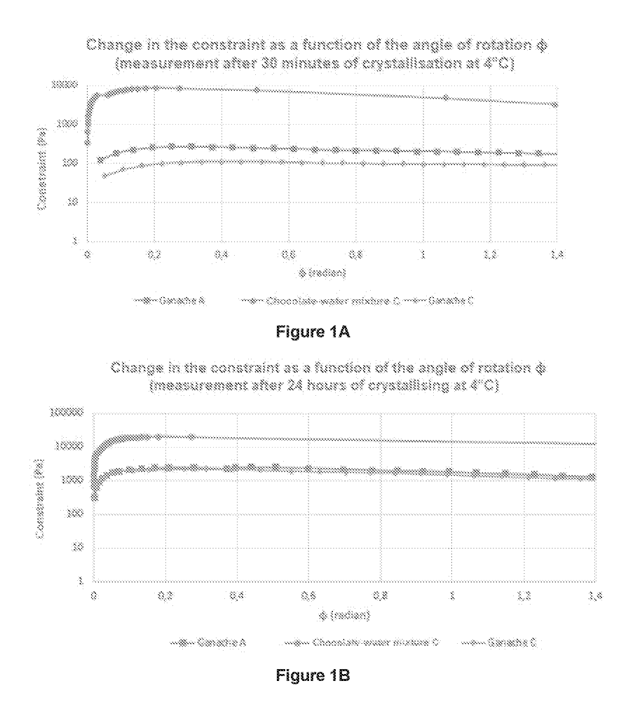

The texture profile after 30 min and 24 h at 4° C. is shown in FIGS. 1A and 1B respectively.

These curves show that the Ganache A and Ganache C products have texture profiles that are substantially close, contrary to the Chocolate-water mixture C.

Ganache A, prepared with a simpler and faster method than the one conventionally implemented for the manufacture of ganache, therefore has the texture of a conventional ganache.
b) Kinematics of Texturizing

Ganaches A and C are followed by a vane shear test in order to determine the texturizing kinematics, (crystallisation) of the applications.

Once the measurement is complete, each one of these products is characterised by:
the maximum constraint read during the measurement (or breaking stress);
the angle of rotation of the vane corresponding to this maximum constraint (or breaking angle);
the “cutability” index, defined as the difference between the breaking stress and the constraint at u/2 rad, standardised by the corresponding angular deviation as well as the breaking stress.

The characteristics mentioned hereinabove vary according to the formulation and the time between the rehydrating of the product and the carrying out of the analysis:
the maximum constraint measured is between 10 Pa and 50′000 Pa;
the breaking angle measured varies between 0.05 rad and 2 rad;
the “cutability” index varies between −1 and 2.

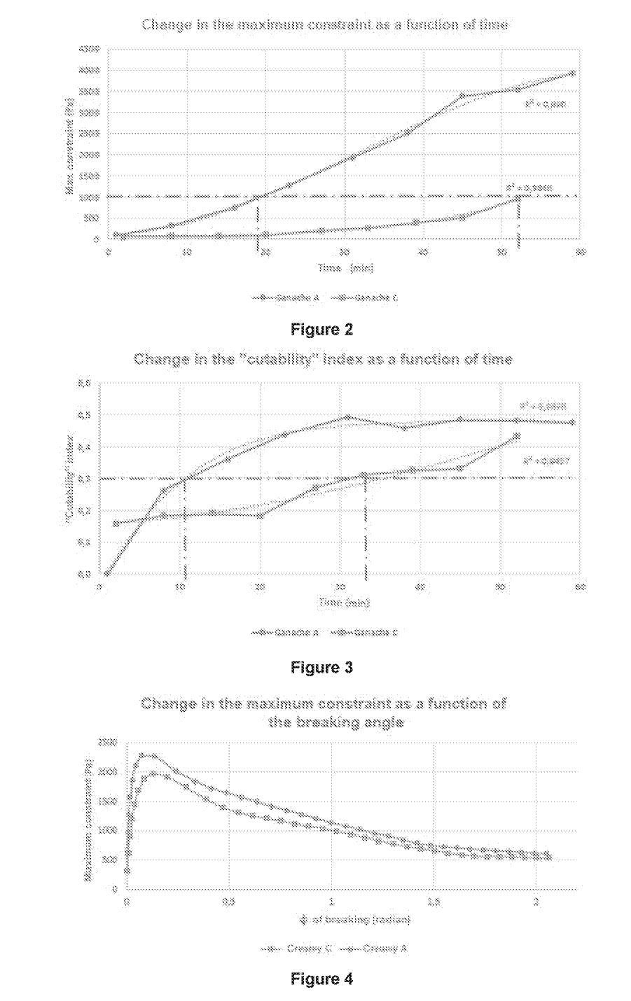

It is observed on these two graphs that the maximum constraint threshold (FIG. 2) and that for “cutability” (FIG. 3) for an application of the ganache type are achieved faster for Ganache A than for Ganache C.

Thus, using Product A for the manufacture of a ganache has both the advantage of a simplified method but also that of obtaining a prepared product faster.

These tests were reproduced for a Creamy A obtained with the Product A and a more substantial quantity of hydrating agent than for Ganache A, and a Creamy C.

Product A and Chocolate C are the same as hereinabove.

The conventional recipe used for the Creamy C is as follows: Bring to a boil a mixture of 500 g of cream (35% fat), 500 g of whole milk and pour on 200 g of egg yolks that were mixed beforehand with 100 g of sugar and finally cook the preparation at 82/84° C. This preparation is mixed with 540 g of Chocolate C until a homogeneous texture is obtained.

The manufacture of Creamy A is as follows: Pour 45% boiling water on the Product A and homogenise the preparation by stirring.

The profiles obtained for these two products are shown in FIG. 4.

These tests show that the preparation of a creamy with a Product A is simpler, faster and uses only one additional ingredient (in this case, water) contrary to that of a conventional cream; furthermore, the creamy obtained with the Product A has a texture equivalent to that of a conventional recipe.

All of these tests experimentally confirm that the use of said product advantageously simplifies the work of the person skilled in the art by reducing the overall implementation time and by limiting the manufacturing constraints (storage of raw materials, work space management, controlling the manufacturing parameters, etc.). The implementation of said product facilitates the division of the prepared food products into different textures for a given aromatic profile while still limiting the risk of defects that can occur during the implementation of the various ingredients.

More generally, the anhydrous food product offers the possibility of preparing prepared food products having a very large range of textures.

IV. Example of Anhydrous Product Recipes According to the Invention

1. An anhydrous food product comprising:
between 15% and 40% by weight of cocoa butter;
between 3% and 50% by weight of dry plant material;
between 10% and 38% by weight of mono-, di- and/or polysaccharides;
between 10% and 40% by weight of fat having a solid fat content less than or equal to 40% at 20° C.;
optionally up to 30% by weight of dry dairy material;
optionally up to 20% by weight of sweetening agent;
optionally up to 8% by weight of spices;
optionally up to 5% by weight of emulsifier;
a weight ratio between the fat having a solid fat content less than or equal to 40% at 20° C. and the cocoa butter is greater than 0.25;
a water content less than 5% by weight; and
the dry material of the product has a D(90) less than or equal to 50 microns in the finished product.

2. The anhydrous food product according to claim 1, wherein the dry plant material is dry non-fat cocoa powder and represents between 3% and 40% by weight, and in that the mono-, di- and/or polysaccharides represent between 15% and 38% by weight.

3. The anhydrous food product according to claim 2, wherein:
the cocoa butter represents between 20% and 40% by weight;
the dry non-fat cocoa powder represents between 10% and 40% by weight;
the mono-, di- and/or polysaccharides represent between 20% and 38% by weight;
the fat having a solid fat content less than or equal to 40% at 20° C. represents between 10% and 30% by weight;
the weight of the dry dairy material, when present, represents up to 20% by weight, and
the spices, when present, represent up to 5% by weight.

4. The anhydrous food product according to claim 2, wherein:
the cocoa butter represents between 15% and 30% by weight;
the dry non-fat cocoa powder represents between 3% and 20% by weight;
the mono-, di- and/or polysaccharides represent between 20% and 38% by weight;
the fat having a solid fat content less than or equal to 40% at 20° C. represents between 10% and 20% by weight;
the dry dairy material represents between 10% and 30% by weight, and
the spices, when present, represent up to 5% by weight.

5. The anhydrous food product according to claim 1, wherein the dry plant material is a fruit and/or a dehydrated vegetable and the mono-, di- and/or polysaccharides represent between 15% and 50% by weight.

6. The anhydrous food product according to claim 1, wherein the weight ratio between the total fat and the total non-fat dry material is greater than or equal to 0.70.

7. A method for the production of the anhydrous food product according to claim 1, this method comprising the following steps:
a) grinding and homogenizing of the various ingredients of said product until a mass is obtained of which the grain size is characterized by a D(90) less than or equal to 50 microns; this mass is then homogenized by stirring by maintaining a temperature between 35 and 75° C.;
b) tempering of the product, in order to control the crystallization of the coco butter and of the fat having a solid fat content less than or equal to 40% at 20° C., for an optimum implementation of the product;
c) molding of the product obtained at the end of the step b) of tempering.

8. A method of manufacturing a prepared food product, comprising including the anhydrous food product according to claim 1 as an ingredient of the prepared food product.

9. A prepared food product comprising the anhydrous food product according to claim 1 and a hydrating agent formed from at least 80% by weight of water, wherein the hydrating agent/anhydrous food product weight ratio is between 0.1 and 4.

10. The prepared food product according to claim 9, wherein the hydrating agent is an aqueous liquid chosen from water, infusions, soups, teas, coffee, fruit juices, vegetable juices, plant juices, fish or meat juice and animal or plant milks and mixtures thereof

11. The prepared food product according to claim 9 wherein the prepared food product is a whipped prepared food product and in that the quantity of hydrating agent is between 20% and 50% by weight based on the total weight of said product.

12. A method for manufacturing a prepared and whipped food product according to claim 11, wherein the method comprises the steps of:
mixing said hydrating agent and said anhydrous food product; and
whipping said mixture with a system for incorporating gas.

13. The prepared food product according to claim 9 wherein the prepared food product is an ice cream and in that the quantity of hydrating agent is between 20% and 60% by weight based on the total weight of said product.

14. A method for manufacturing an ice cream according to claim 13, wherein the method comprises the steps of:
mixing said hydrating agent and said anhydrous food product;
mixing and processing said mixture between −6 and −10° C.; and
storing in the freezer.
